(19) United States
(12) Patent Application Publication
(10) Pub. No.: US 2026/0284571 A1
(43) Pub. Date: Sep. 24, 2026

(54) CARBON DIOXIDE RECOVERY APPARATUS

(71) Applicant: HONDA MOTOR CO., LTD., Tokyo (JP)

(72) Inventor: Hibiki Kimura, Wako-shi (JP)

(21) Appl. No.: 19/551,652

(22) Filed: Feb. 27, 2026

(30) Foreign Application Priority Data
Mar. 18, 2025 (JP) 2025-043350

(51) Int. Cl. B01D 53/04

(52) U.S. Cl. CPC B01D 53/0438; B01D 53/0454; B01D 2257/504; B01D 2259/40098; B01D 2259/65

(57) ABSTRACT

A heat medium circuit of a carbon dioxide recovery apparatus includes a heat pump, high-temperature side and low-temperature side tanks, a solar collector, high-temperature side and low-temperature side temperature sensors, a solar radiation sensor, and a control device. The heat pump heats a reactor with a high-temperature heat medium of the high-temperature side tank and cools the reactor with a low-temperature heat medium of the low-temperature side tank. The solar collector heats the heat medium by using solar thermal energy. Each temperature sensor detects a temperature of the heat medium of each tank. The solar radiation sensor detects an amount of solar radiation at the solar collector. The control device switches circulation of the heat medium from the solar collector to each tank in accordance with the temperature of the heat medium of each tank and the amount of solar radiation.

### CROSS-REFERENCE TO RELATED APPLICATION

Priority is claimed on Japanese Patent Application No. 2025-043350, filed Mar. 18, 2025, the contents of which are incorporated herein by reference.

### BACKGROUND

### Field of the Invention

The present invention relates to a carbon dioxide recovery apparatus.

### Background

Efforts aimed at mitigating or reducing the impact of climate change have been ongoing, and research and development related to reduction in discharge amount of carbon dioxide has been conducted to achieve this.

Conventionally, for example, a system is known in which a gas to be processed, such as air, is supplied to a direct air capture (DAC) device equipped with a carbon dioxide adsorbent and a plurality of different power sources, and carbon dioxide is recovered by the DAC device adsorbing and desorbing (releasing) the carbon dioxide (for example, refer to Japanese Unexamined Patent Application, First Publication No. 2024-125480). This system is equipped with a plurality of different power sources, such as a solar panel, a battery, and a commercial power source.

### SUMMARY

In reducing the discharge amount of carbon dioxide, it is important to suppress the increase in power consumption required for carbon dioxide recovery. For example, in a system like the conventional technology described above, when heat is stored from solar panels in a heat pump that supplements adsorbent heating, simply supplying heat only to a specific portion of the heat pump at all times may not improve an operating efficiency of the heat pump and reduction in power consumption.

The present application aims to suppress an increase in power consumption required for carbon dioxide recovery. This application, in turn, contributes to mitigating or reducing the impact of climate change.

A carbon dioxide recovery apparatus according to a first aspect of the present invention includes: a reactor having an adsorbent that adsorbs carbon dioxide and configured to adsorb and desorb carbon dioxide of a gas to be processed by using the adsorbent; a heat pump configured to heat the reactor with a first heat medium having a relatively high temperature and cool the reactor with a first heat medium having a relatively low temperature; a solar collector configured to transfer solar thermal energy to a second heat medium; a first flow path configured to circulate the second heat medium that heats the first heat medium having the relatively high temperature and a second flow path configured to circulate the second heat medium that heats the first heat medium having the relatively low temperature; a switching portion configured to switch circulation of the second heat medium from the solar collector to the first flow path or the second flow path; a temperature acquisition portion configured to acquire a temperature of the first heat medium; a solar radiation amount acquisition portion configured to acquire an amount of solar radiation received by the solar collector; and a control device configured to control an operation of the switching portion in accordance with temperature information of the first heat medium output from the temperature acquisition portion and solar radiation amount information output from the solar radiation amount acquisition portion.

A second aspect is the carbon dioxide recovery apparatus described in the first aspect described above, wherein the control device may set a first region in which the first heat medium recovers heat from the second heat medium and a second region in which the first heat medium does not recover heat from the second heat medium to the temperature information and the solar radiation amount information, and circulate the second heat medium through the first flow path when a temperature of the first heat medium having the relatively low temperature is equal to or higher than a predetermined temperature and in the first region with respect to the first heat medium having the relatively high temperature.

A third aspect is the carbon dioxide recovery apparatus described in the second aspect described above, wherein the control device may circulate the second heat medium through the second flow path when the temperature of the first heat medium having the relatively low temperature is lower than the predetermined temperature or in the second region with respect to the first heat medium having the relatively high temperature and is in the first region with respect to the first heat medium having the relatively low temperature.

A fourth aspect is the carbon dioxide recovery apparatus described in the third aspect described above, wherein the control device may stop circulation of the second heat medium in the solar collector when the temperature of the first heat medium having the relatively low temperature is lower than the predetermined temperature or in the second region with respect to the first heat medium having the relatively high temperature and is in the second region with respect to the first heat medium having the relatively low temperature.

A fifth aspect is the carbon dioxide recovery apparatus described in any one of the first to fourth aspects described above which may include: a bypass flow path configured to bypass circulation of the second heat medium with respect to the first heat medium in the first flow path or the second flow path; and a bypass switching portion configured to switch whether or not the second heat medium is circulated in the bypass flow path, wherein the control device may circulate the second heat medium through the bypass flow path in a standby state.

In the first aspect described above, by including a control device that switches the circulation of the second heat medium in accordance with the temperature information of the first heat medium and solar radiation amount information, it is possible to improve an operating efficiency of the heat pump, suppress an increase in power consumption of the solar collector, and suppress an increase in power consumption required for carbon dioxide recovery.

In the case of the second aspect described above, when the temperature of the first heat medium having the relatively low temperature is equal to or higher than the predetermined temperature, it is possible to ensure desired heat dissipation by the first heat medium having the low temperature. By preferentially circulating the second heat medium through the first flow path, it is possible to suppress an increase in power consumption required for heating the first heat medium having the relatively high temperature in the heat pump.

In the case of the third aspect described above, when the temperature of the first heat medium having the relatively low temperature is lower than the predetermined temperature, it may be difficult to ensure desired heat dissipation by the first heat medium having the low temperature. By preferentially circulating the second heat medium through the second flow path, it is possible to improve an operating efficiency of the heat pump and the solar collector.

In the case of the fourth aspect described above, at least when the temperature is in the second region with respect to the first heat medium having the relatively low temperature, by stopping circulation of the second heat medium, it is possible to suppress an unnecessary increase in power consumption of the solar collector.

In the case of the fifth aspect described above, in the standby state, by circulating the second heat medium with respect to the solar collector without heating the first heat medium by the second heat medium, it is possible to suppress a temperature drop in the second heat medium and prepare for rapid heating of the first heat medium.

### BRIEF DESCRIPTION OF THE DRAWINGS

FIG. 1 is a configuration diagram of a heat medium circuit in a carbon dioxide recovery apparatus according to an embodiment of the present invention.

FIG. 2 is a diagram showing a flow of a heat medium in a first mode of the heat medium circuit shown in FIG. 1.

FIG. 3 is a diagram showing a flow of the heat medium in a second mode of the heat medium circuit shown in FIG. 1.

FIG. 4 is a graph diagram showing examples of first and second regions set in relation to a heat medium temperature and an amount of solar radiation in the heat medium circuit shown in FIG. 1.

FIG. 5 is a flowchart showing an operation of the heat medium circuit shown in FIG. 1.

FIG. 6 is a diagram showing a flow of the heat medium in a fourth mode (standby state) of a heat medium circuit of a carbon dioxide recovery apparatus according to a first modified example of the embodiment of the present invention.

FIG. 7 is a diagram showing a flow of the heat medium in a fourth mode (standby state) of a heat medium circuit of a carbon dioxide recovery apparatus according to a second modified example of the embodiment of the present invention.

### DESCRIPTION OF EMBODIMENTS

A carbon dioxide recovery apparatus according to an embodiment of the present invention will be described below with reference to the accompanying drawings.

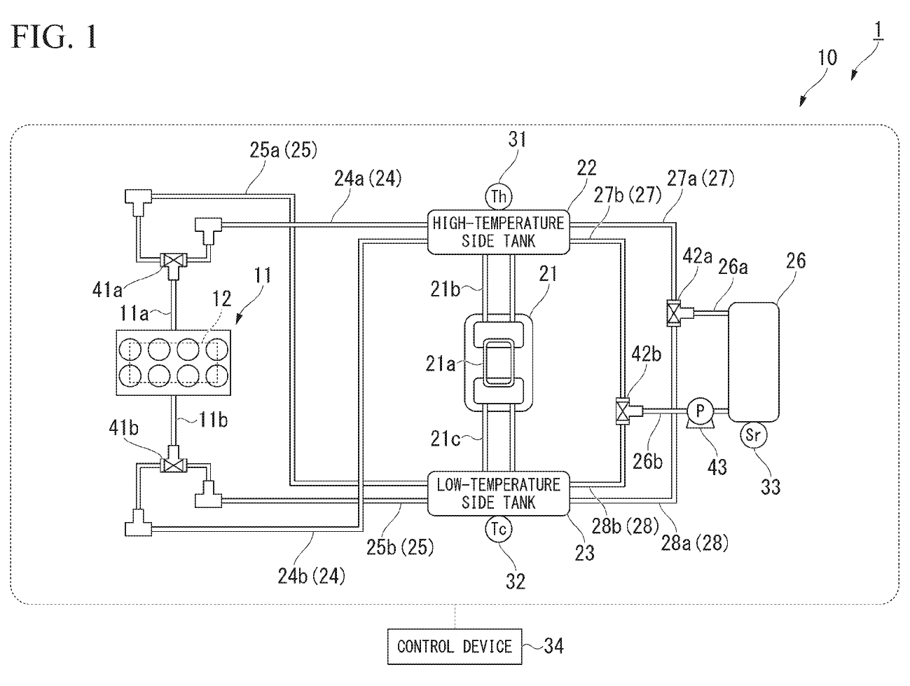

FIG. 1 is a configuration diagram of a heat medium circuit 10 in a carbon dioxide recovery apparatus 1 according to an embodiment. The carbon dioxide recovery apparatus 1 according to an embodiment is used in so-called direct air capture (DAC: a direct air recovery technology) and recovers carbon dioxide directly from the atmosphere containing diffused carbon dioxide.

A heat medium circuit 10 of the carbon dioxide recovery apparatus 1 according to an embodiment is connected to, for example, a plurality of reactors 11. Each of the plurality of reactors 11 includes, for example, a housing, a heat exchanger disposed inside the housing, and an adsorbent 12 held by the heat exchanger. The heat exchanger is, for example, a radiator or the like. The heat exchanger includes a flow path for a heat medium formed inside and a plurality of fins provided on its outer surface. The heat exchanger holds the adsorbent 12, which each of a plurality of cells formed by the plurality of fins on its outer surface is filled with.

A heat exchanger of each reactor 11 constitutes part of the heat medium circuit 10. The heat exchanger heats and cools the adsorbent 12 through heat exchange between the heat medium circulating in the heat medium circuit 10 and the adsorbent 12. For example, the heat medium supplied to a supply-side flow path 11a of the heat exchanger of each reactor 11 flows through an internal flow path of the heat exchanger, exchanges heat with the adsorbent 12, and is then discharged to a discharge-side flow path 11b of the heat exchanger.

An outer shape of the adsorbent 12 is, for example, a particulate shape. The adsorbent 12 is formed from, for example, a porous material such as silica and a solid amine supported on the porous material. The adsorbent 12 adsorbs carbon dioxide at low temperatures and desorbs (releases) carbon dioxide at high temperatures and when a concentration of the ambient carbon dioxide is low.

The heat medium circuit 10 includes, for example, a heat pump 21, a high-temperature side tank 22, a low-temperature side tank 23, a high-temperature side flow path 24, a low-temperature side flow path 25, a solar collector 26, a first flow path 27, a second flow path 28, a high-temperature side temperature sensor 31 (temperature acquisition portion), a low-temperature side temperature sensor 32 (temperature acquisition portion), a solar radiation sensor 33 (solar radiation amount acquisition portion), and a control device 34.

The heat pump 21 includes, for example, a circulation flow path 21athat circulates a heat exchange medium, a high-temperature side heat medium flow path 21b connected to the high-temperature side tank 22, and a low-temperature side heat medium flow path 21cconnected to the low-temperature side tank 23. As a temperature of the heat exchange medium flowing through the circulation flow path 21a increases and decreases due to compression and expansion, the heat pump 21 heats and cools the heat medium supplied to the flow paths 21b and 21c from the high-temperature side tank 22 and the low-temperature side tank 23, respectively, by heat exchange with the heat exchange medium.

The high-temperature side tank 22 and the low-temperature side tank 23 each store the heat medium that exchanges heat with the heat exchange medium of the heat pump 21. The high-temperature side tank 22 stores a heat medium having a relatively high temperature that is heated by flowing through the high-temperature side heat medium flow path 21b between the high-temperature side tank 22 and the heat pump 21. The low-temperature side tank 23 stores a heat medium having a relatively low temperature that is cooled by flowing through the low-temperature side heat medium flow path 21c between the low-temperature side tank 23 and the heat pump 21.

The high-temperature side flow path 24 is formed, for example, by a pipe, a tube, or the like. The high-temperature side flow path 24 forms a circulation flow path that circulates the heat medium having the relatively high temperature between the high-temperature side tank 22 and the heat exchanger of each reactor 11. The high-temperature side flow path 24 includes, for example, a high-temperature side outgoing flow path 24athat circulates the heat medium from the high-temperature side tank 22 toward the heat exchanger of each reactor 11, and a high-temperature side return flow path 24b that circulates the heat medium from the heat exchanger of each reactor 11 toward the high-temperature side tank 22.

The low-temperature side flow path 25 is formed, for example, by a pipe or a tube. The low-temperature side flow path 25 forms a circulation flow path that circulates the heat medium having the relatively low temperature between the low-temperature side tank 23 and the heat exchanger of each reactor 11. The low-temperature side flow path 25 includes, for example, a low-temperature side outgoing flow path 25athat circulates the heat medium from the low-temperature side tank 23 toward the heat exchanger of each reactor 11, and a low-temperature side return flow path 25b that circulates the heat medium from the heat exchanger of each reactor 11 toward the low-temperature side tank 23.

The high-temperature side outgoing flow path 24aand the low-temperature side outgoing flow path 25a are connected to the supply-side flow path 11a of the heat exchanger of each reactor 11, for example, via a supply-side three-way valve 41a. The supply-side three-way valve 41aswitches connection between the supply-side flow path 11a of the heat exchanger of each reactor 11 and the high-temperature side outgoing flow path 24a or the low-temperature side outgoing flow path 25a.

The high-temperature side return flow path 24band the low-temperature side return flow path 25b are connected to the discharge-side flow path 11b of the heat exchanger of each reactor 11, for example, via a discharge-side three-way valve 41b. The discharge-side three-way valve 41bswitches connection between the discharge-side flow path 11b of the heat exchanger of each reactor 11 and the high-temperature side return flow path 24b or the low-temperature side return flow path 25b.

The solar collector 26 heats the heat medium circulating between the high-temperature side tank 22 and the low-temperature side tank 23, for example, by converting solar light energy into thermal energy.

The first flow path 27 is formed, for example, by a pipe or tube. The first flow path 27 forms a circulation flow path that circulates the heat medium between the high-temperature side tank 22 and the solar collector 26. The first flow path 27 includes, for example, a first outgoing flow path 27a that circulates the heat medium from the solar collector 26 toward the high-temperature side tank 22, and a first return flow path 27bthat circulates the heat medium from the high-temperature side tank 22 toward the solar collector 26.

The second flow path 28 is formed, for example, by a pipe or tube. The second flow path 28 forms a circulation flow path that circulates the heat medium between the low-temperature side tank 23 and the solar collector 26. The second flow path 28 includes, for example, a second outgoing flow path 28a that circulates the heat medium from the solar collector 26 toward the low-temperature side tank 23, and a second return flow path 28bthat circulates the heat medium from the low-temperature side tank 23 toward the solar collector 26.

The first outgoing flow path 27a and the second outgoing flow path 28a are connected to an outgoing flow path 26a of the solar collector 26, for example, via an outlet three-way valve 42a (switching portion). The outlet three-way valve 42a switches connection between the outgoing flow path 26a of the solar collector 26 and the first outgoing flow path 27a or the second outgoing flow path 28a.

The first return flow path 27b and the second return flow path 28b are connected to a return flow path 26b of the solar collector 26, for example, via a return three-way valve 42b (switching portion). The return three-way valve 42bswitches connection between the return flow path 26b of the solar collector 26 and the first return flow path 27b or the second return flow path 28b.

Note that, for example, the return flow path 26b of the solar collector 26 includes a pump 43 that circulates the heat medium in each of the first flow path 27 and the second flow path 28.

The high-temperature side temperature sensor 31 detects a temperature Th of the heat medium having the relatively high temperature stored in the high-temperature side tank 22. The low-temperature side temperature sensor 32 detects a temperature Tc of the heat medium having the relatively low temperature stored in the low-temperature side tank 23.

The solar radiation sensor 33 detects the amount of solar radiation in the solar collector 26.

The control device 34, for example, provides overall control over the operation of the carbon dioxide recovery apparatus 1. For example, the control device 34 is a software functionality unit that functions when a processor such as a CPU (Central Processing Unit) executes a specified program. The software functionality unit is an ECU (Electronic Control Unit) equipped with a processor such as a CPU, ROM (Read Only Memory) for storing programs, RAM (Random Access Memory) for temporarily storing data, and electronic circuits such as a timer. Note that at least a portion of the control device 34 may be an integrated circuit such as an LSI (Large Scale Integration).

An operation of the heat medium circuit 10 of the carbon dioxide recovery apparatus 1 of the embodiment will be described below.

The control device 34 controls circulation of the heat medium between each of the high-temperature side tank 22 and the low-temperature side tank 23 and the solar collector 26, based on, for example, detected values of the heat medium temperatures Th and Tc output from each of the high-temperature side temperature sensor 31 and the low-temperature side temperature sensor 32, and a detected value of the amount of solar radiation output from the solar radiation sensor 33. The control device 34 switches the operation of the heat medium circuit 10 between a first mode, a second mode, and a third mode, for example.

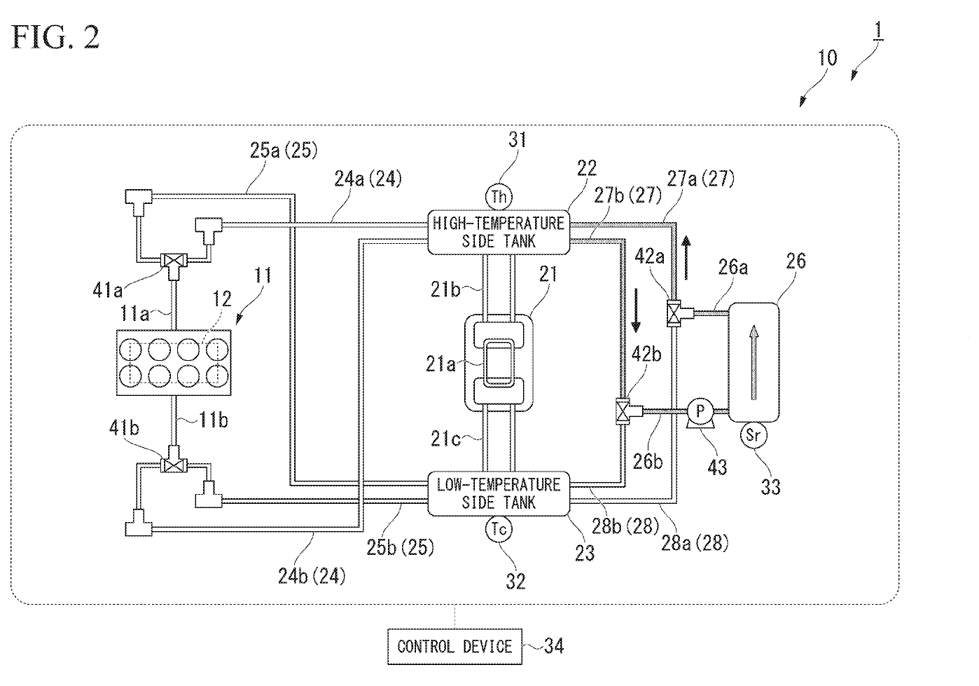

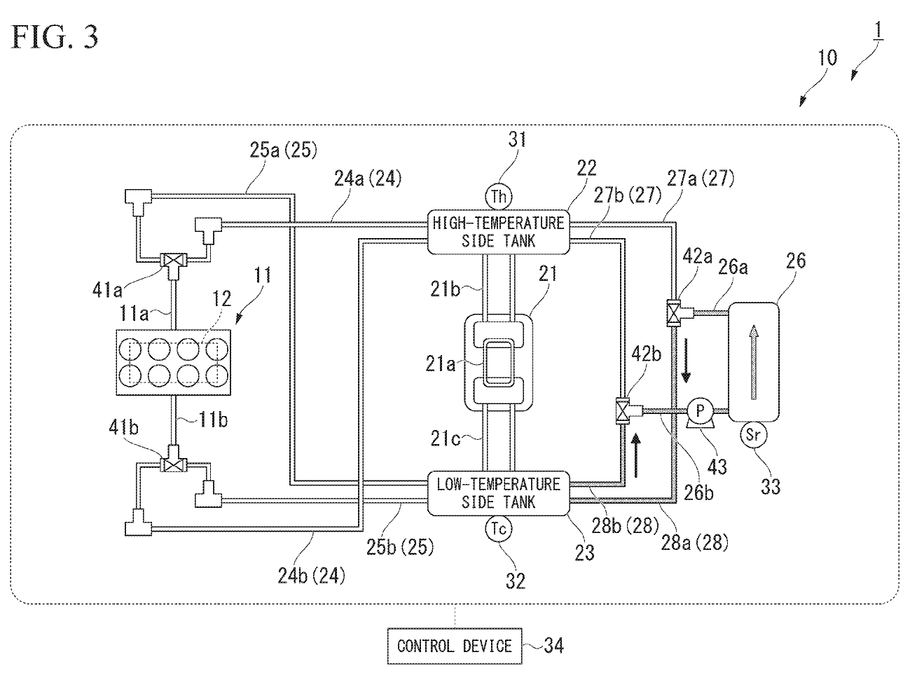

FIG. 2 is a diagram which shows a flow of the heat medium in the first mode of the heat medium circuit 10 of the embodiment. FIG. 3 is a diagram which shows a flow of the heat medium in the second mode of the heat medium circuit 10 of the embodiment.

As shown in FIG. 2, for example, in the first mode, the control device 34 circulates the heat medium heated by the solar collector 26 toward the high-temperature side tank 22 sequentially through the outgoing flow path 26a, the outlet three-way valve 42a, and the first outgoing flow path 27a. The control device 34 circulates the heat medium from the high-temperature side tank 22 toward the solar collector 26 sequentially through the first return flow path 27b, the return three-way valve 42b, and the return flow path 26b.

As shown in FIG. 3, in the second mode, for example, the control device 34 circulates the heat medium heated by the solar collector 26 toward the low-temperature side tank 23 sequentially through the outgoing flow path 26a, the outlet three-way valve 42a, and the second outgoing flow path 28a. The control device 34 circulates the heat medium from the low-temperature side tank 23 toward the solar collector 26 sequentially through the second return flow path 28b, the return three-way valve 42b, and the return flow path 26b.

In the third mode, for example, the control device 34 stops the circulation of the heat medium in the solar collector 26 by stopping an operation of the pump 43, and the like.

The control device 34 switches between the first mode, the second mode, and the third mode, for example, depending on whether the heat medium having the relatively high temperature stored in the high-temperature side tank 22 or the heat medium having the relatively low temperature stored in the low-temperature side tank 23 can recover heat from the heat medium heated by the solar collector 26.

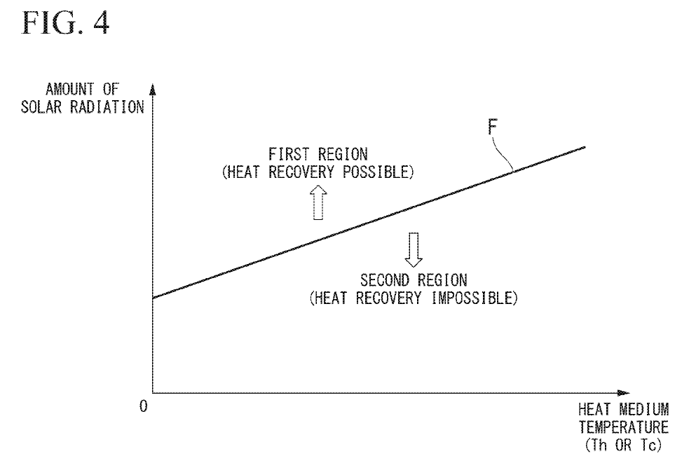

FIG. 4 is a graph diagram which shows examples of first and second regions set in relation to the heat medium temperature (Th or Tc) in the heat medium circuit 10 and the amount of solar radiation in the solar collector 26 of the embodiment.

As shown in FIG. 4, the control device 34 sets the first and second regions in accordance with, for example, each of the temperature Th of the heat medium having the relatively high temperature stored in the high-temperature side tank 22 and the temperature Tc of the heat medium having the relatively low temperature stored in the low-temperature side tank 23, and the amount of solar radiation in the solar collector 26. The first region is a region where the heat medium in the high-temperature side tank 22 or the low-temperature side tank 23 can recover heat from the heat medium heated by the solar collector 26. The first region is, for example, a region where a temperature of a heat medium supplied from the solar collector 26 is higher than the temperatures Th and Tc of the heat medium in the high-temperature side tank 22 or the low-temperature side tank 23. The second region is a region where the heat medium in the high-temperature side tank 22 or the low-temperature side tank 23 cannot recover heat from the heat medium heated by the solar collector 26. The second region is, for example, a region where the temperature of the heat medium supplied from the solar collector 26 is equal to or lower than the temperatures Th and Tc of the heat medium in the high-temperature side tank 22 or the low-temperature side tank 23.

In the example shown in FIG. 4, the control device 34 sets the first region and the second region using an appropriate linear function F related to the temperatures Th and Tc of each heat medium and the amount of solar radiation.

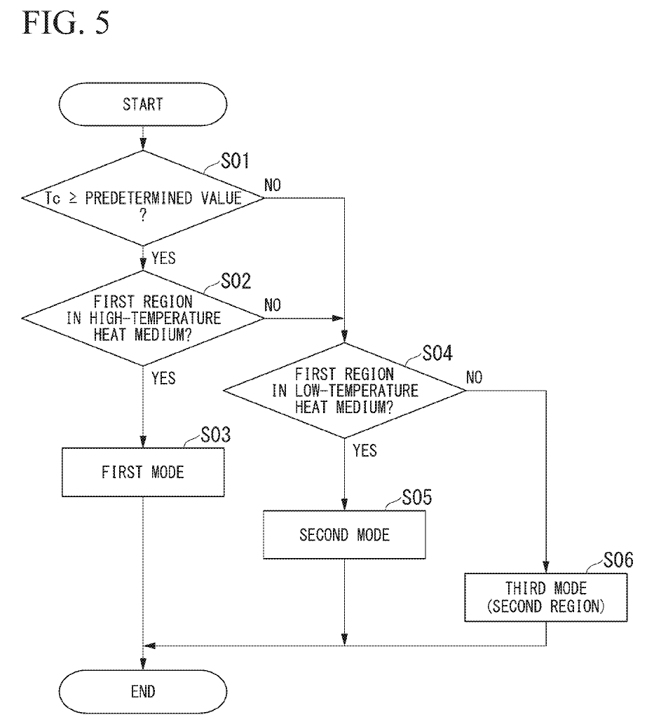

FIG. 5 is a flowchart which shows the operation of the heat medium circuit 10 of the embodiment.

As shown in FIG. 5, the control device 34 first determines whether the temperature Tc of the heat medium in the low-temperature side tank 23 is equal to or higher than a predetermined value (step S01). The predetermined value is, for example, a temperature or the like that can ensure the desired heat dissipation from the heat medium in the low-temperature side tank 23. The predetermined value is, for example, 40° C, or the like. When a result of this determination is "YES," the control device 34 advances the processing to step S02. On the other hand, when the result of this determination is "NO," the control device 34 advances the processing to step S04.

Next, the control device 34 determines whether it is the first region based on the temperature Th of the heat medium (high-temperature heat medium) in the high-temperature side tank 22 and the amount of solar radiation in the solar collector 26 (step S02).

When a result of this determination is "YES," the control device 34 proceeds to step S03. On the other hand, if the determination is "NO," the control device 34 advances the processing to step S04.

Next, the control device 34 sets the operation of the heat medium circuit 10 to the first mode (step S03). Then, the processing proceeds to end.

Furthermore, the control device 34 determines whether it is the first region based on the temperature Tc of the heat medium (low-temperature heat medium) in the low-temperature side tank 23 and the amount of solar radiation in the solar collector 26 (step S04).

When a result of this determination is "YES," the control device 34 advances the processing to step S05. On the other hand, when the result of this determination is "NO," the control device 34 advances the processing to step S06.

Next, the control device 34 sets the operation of the heat medium circuit 10 to the second mode (step S05). Then, the processing proceeds to end.

The control device 34 also sets the operation of the heat medium circuit 10 to the third mode (step S06). Then, the processing proceeds to end.

As described above, according to the carbon dioxide recovery apparatus 1 of the embodiment, the operation of the heat medium circuit 10 is switched depending on the temperature Th or Tc of the heat medium in the high-temperature side tank 22 or low-temperature side tank 23 and the amount of solar radiation in the solar collector 26, thereby suppressing an increase in power consumption required for carbon dioxide recovery.

When the temperature Tc of the heat medium in the low-temperature side tank 23 is equal to or higher than a predetermined value, the desired heat dissipation from the heat medium in the low-temperature side tank 23 can be ensured. In the first mode, which preferentially circulates the heat medium from the solar collector 26 through the first flow path 27, the increase in power consumption required by the heat pump 21 to heat the heat medium in the high-temperature side tank 22 can be suppressed.

When the temperature Tc of the heat medium in the low-temperature side tank 23 is lower than the predetermined temperature, it may be difficult to ensure the desired heat dissipation from the heat medium in the low-temperature side tank 23. In the second mode, which preferentially circulates the heat medium from the solar collector 26 through the second flow path 28, the desired heat dissipation from the heat medium in the low-temperature side tank 23 can be ensured. The heat pump 21 becomes more efficient as a temperature difference between the high-temperature side and the low-temperature side decreases. Therefore, the second mode can improve the operating efficiency of the heat pump 21 and suppress an increase in power consumption. The solar collector 26 dissipates less heat as the heat medium has a lower temperature, and an amount of heat collected increases as the heat medium having a lower temperature is heated. This can improve the operating efficiency of the solar collector 26.

At least when the region is the second region for the heat medium in the low-temperature side tank 23, in the third mode, which stops circulation of the heat medium in the solar collector 26, it is possible to suppress an unnecessary increase in power consumption by the solar collector 26.

### Modified example

The following describes modified examples of the embodiment. Note that the same parts as those in the embodiment described above are designated by the same reference numerals, and their descriptions will be omitted or simplified.

In the embodiment described above, the control device 34 sets operating modes of the heat medium circuit 10 of the carbon dioxide recovery apparatus 1 to the first mode, second mode, and third mode, but this is not limited thereto. For example, the control device 34 may set the operating mode of the heat medium circuit 10 to a fourth mode.

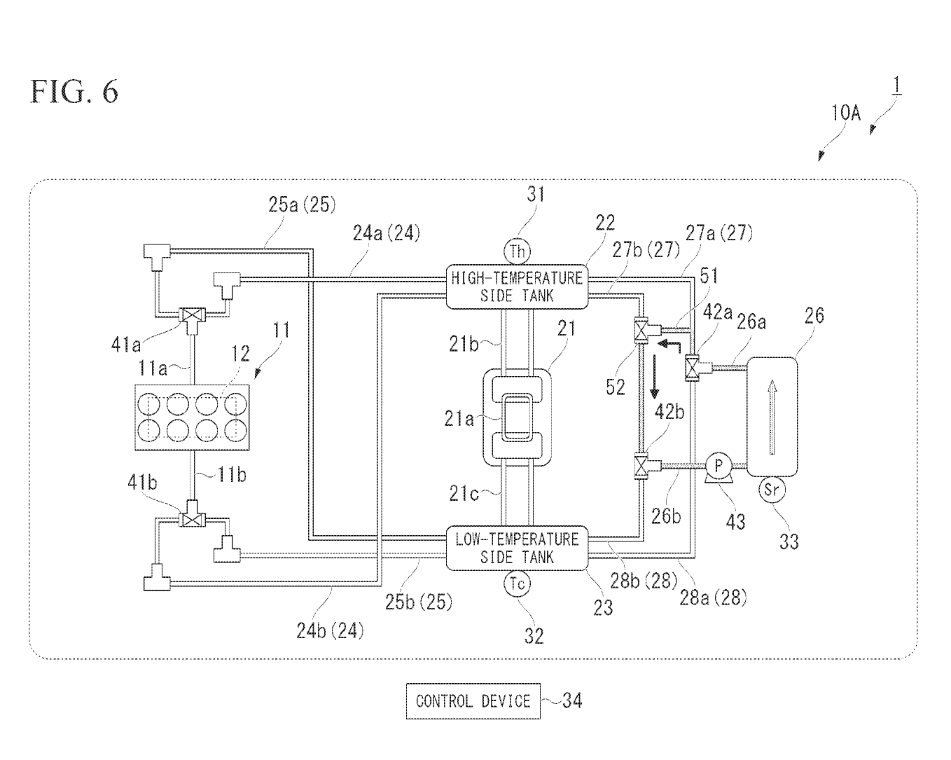

FIG. 6 is a diagram which shows a flow of the heat medium in the fourth mode (standby state) of a heat medium circuit 10A of the carbon dioxide recovery apparatus 1 in a first modified example of the embodiment.

As shown in FIG. 6, the heat medium circuit 10A of the first modified example includes a high-temperature side bypass flow path 51 and a high-temperature side bypass three-way valve 52 (bypass switching portion) in addition to the configuration of the heat medium circuit 10 of the embodiment described above.

The high-temperature side bypass flow path 51 and the high-temperature side bypass three-way valve 52 connect the first outgoing flow path 27a and the first return flow path 27b, for example, to bypass the high-temperature side tank 22.

The high-temperature side bypass flow path 51 branches off from the first outgoing flow path 27a, for example, to bypass the high-temperature side tank 22, and is connected to the first return flow path 27bvia the high-temperature side bypass three-way valve 52.

The high-temperature side bypass three-way valve 52 is disposed, for example, in the first return flow path 27b. The high-temperature side bypass three-way valve 52 switches, for example, between connection between the high-temperature side tank 22 side and the return three-way valve 42bside in the first return flow path 27b, and connection between the high-temperature side bypass flow path 51 and the return three-way valve 42bside in the first return flow path 27b.

In the fourth mode (standby state), for example, the control device 34 circulates the heat medium heated by the solar collector 26 sequentially through the outgoing flow path 26a, the outlet three-way valve 42a, a portion of the first outgoing flow path 27a, the high-temperature side bypass flow path 51, the high-temperature side bypass three-way valve 52, a portion of the first return flow path 27b, the return three-way valve 42b, and the return flow path 26b.

According to the first modified example described above, in the fourth mode (standby state), by circulating the heat medium to the solar collector 26 without heating the heat medium in each tank 22 or 23 by the solar collector 26, a temperature drop in the heat medium can be suppressed and rapid heating of the heat medium in each tank 22 or 23 can be prepared.

Note that, while the first modified example of the embodiment includes the high-temperature side bypass flow path 51 and the high-temperature side bypass three-way valve 52, the present invention is not limited thereto.

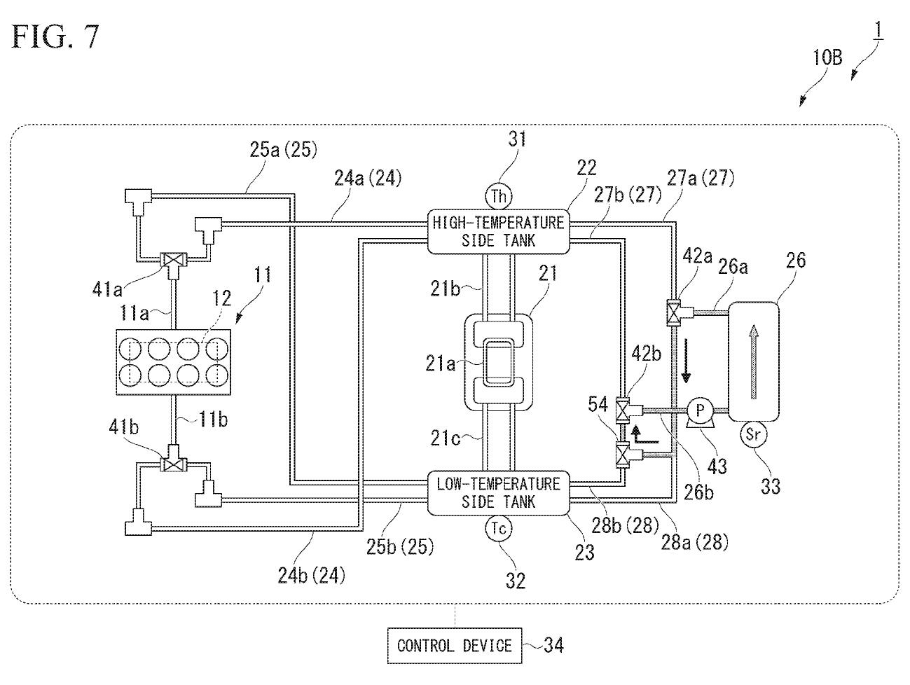

FIG. 7 is a diagram which shows a flow of heat medium in the fourth mode (standby state) of a heat medium circuit 10B of the carbon dioxide recovery apparatus 1 in a second modified example of the embodiment.

As shown in FIG. 7, the heat medium circuit 10B of the second modified example includes, in addition to the configuration of the heat medium circuit 10 of the embodiment described above, a low-temperature side bypass flow path 53 and a low-temperature side bypass three-way valve 54 (bypass switching portion).

The low-temperature side bypass flow path 53 and the low-temperature side bypass three-way valve 54 connect the second outgoing flow path 28a and the second return flow path 28b, for example, to bypass the low-temperature side tank 23.

The low-temperature side bypass flow path 53 branches off from the second outgoing flow path 28a, for example, to bypass the low-temperature side tank 23, and is connected to the second return flow path 28bvia a low-temperature side bypass three-way valve 54.

The low-temperature side bypass three-way valve 54 is disposed, for example, in the second return flow path 28b. The low-temperature side bypass three-way valve 54 switches, for example, between connection between the low-temperature side tank 23 side and the return three-way valve 42bside in the second return flow path 28b, and connection between the low-temperature side bypass flow path 53 and the return three-way valve 42bside in the second return flow path 28b.

In the fourth mode (standby state), for example, the control device 34 circulates the heat medium heated by the solar collector 26 sequentially through the outgoing flow path 26a, the outlet three-way valve 42a, a portion of the second outgoing flow path 28a, the low-temperature side bypass flow path 53, the low-temperature side bypass three-way valve 54, a portion of the second return flow path 28b, the return three-way valve 42b, and the return flow path 26b.

In the embodiment described above, the control device 34 acquires the amount of solar radiation in the solar collector 26 based on a detected value for the amount of solar radiation output from the solar radiation sensor 33. However, the present invention is not limited thereto. For example, the control device 34 may acquire the amount of solar radiation in the solar collector 26 on the basis of weather information acquired from the outside.

In the embodiment described above, the heat medium stored in the high-temperature side tank 22 and the low-temperature side tank 23 and the heat medium heated in the solar collector 26 are the same heat medium, but the present invention is not limited thereto. For example, the heat medium (first heat medium) of each tank 22 or 23 and the heat medium (second heat medium) of the solar collector 26 may be different heat media. For example, each tank 22 or 23 may include a flow path that circulates the heat medium (second heat medium) of the solar collector 26 therein independently of the stored heat medium (first heat medium). The heat medium (first heat medium) of each tank 22 or 23 may be heated by heat exchange with the heat medium (second heat medium) of the solar collector 26.

The embodiments of the present invention are presented as examples and are not intended to limit the scope of the invention. These embodiments may be implemented in a variety of other forms, and various omissions, substitutions, and modifications may be made within a range not departing from the gist of the invention. These embodiments and their variations are included within the scope of the inventions and their equivalents as defined in the accompanying claims, as well as within the scope and gist of the inventions.

What is claimed is:

1. A carbon dioxide recovery apparatus comprising:
a reactor having an adsorbent that adsorbs carbon dioxide and configured to adsorb and desorb carbon dioxide of a gas to be processed by using the adsorbent;
a heat pump configured to heat the reactor with a first heat medium having a relatively high temperature and cool the reactor with a first heat medium having a relatively low temperature;
a solar collector configured to transfer solar thermal energy to a second heat medium;
a first flow path configured to circulate the second heat medium that heats the first heat medium having the relatively high temperature and a second flow path configured to circulate the second heat medium that heats the first heat medium having the relatively low temperature;
a switching portion configured to switch circulation of the second heat medium from the solar collector to the first flow path or the second flow path;
a temperature acquisition portion configured to acquire a temperature of the first heat medium;
a solar radiation amount acquisition portion configured to acquire an amount of solar radiation received by the solar collector; and
a control device configured to control an operation of the switching portion in accordance with temperature information of the first heat medium output from the temperature acquisition portion and solar radiation amount information output from the solar radiation amount acquisition portion.

2. The carbon dioxide recovery apparatus according to claim 1,
wherein the control device sets a first region in which the first heat medium recovers heat from the second heat medium and a second region in which the first heat medium does not recover heat from the second heat medium to the temperature information and the solar radiation amount information, and
circulates the second heat medium through the first flow path when a temperature of the first heat medium having the relatively low temperature is equal to or higher than a predetermined temperature and in the first region with respect to the first heat medium having the relatively high temperature.

3. The carbon dioxide recovery apparatus according to claim 2,
wherein the control device circulates the second heat medium through the second flow path when the temperature of the first heat medium having the relatively low temperature is lower than the predetermined temperature or in the second region with respect to the first heat medium having the relatively high temperature and is in the first region with respect to the first heat medium having the relatively low temperature.

4. The carbon dioxide recovery apparatus according to claim 3,
wherein the control device stops circulation of the second heat medium in the solar collector when the temperature of the first heat medium having the relatively low temperature is lower than the predetermined temperature or in the second region with respect to the first heat medium having the relatively high temperature and is in the second region with respect to the first heat medium having the relatively low temperature.

5. The carbon dioxide recovery apparatus according to claim 1, comprising:
a bypass flow path configured to bypass circulation of the second heat medium with respect to the first heat medium in the first flow path or the second flow path; and
a bypass switching portion configured to switch whether or not the second heat medium is circulated in the bypass flow path,
wherein the control device circulates the second heat medium through the bypass flow path in a standby state.

6. The carbon dioxide recovery apparatus according to claim 2, comprising:
a bypass flow path configured to bypass circulation of the second heat medium with respect to the first heat medium in the first flow path or the second flow path; and
a bypass switching portion configured to switch whether or not the second heat medium is circulated in the bypass flow path,
wherein the control device circulates the second heat medium through the bypass flow path in a standby state.

7. The carbon dioxide recovery apparatus according to claim 3, comprising:
a bypass flow path configured to bypass circulation of the second heat medium with respect to the first heat medium in the first flow path or the second flow path; and
a bypass switching portion configured to switch whether or not the second heat medium is circulated in the bypass flow path,
wherein the control device circulates the second heat medium through the bypass flow path in a standby state.

8. The carbon dioxide recovery apparatus according to claim 4, comprising:
a bypass flow path configured to bypass circulation of the second heat medium with respect to the first heat medium in the first flow path or the second flow path; and
a bypass switching portion configured to switch whether or not the second heat medium is circulated in the bypass flow path,
wherein the control device circulates the second heat medium through the bypass flow path in a standby state.
